(19) United States
(12) Patent Application Publication
(10) Pub. No.: US 2005/0232607 A1
(43) Pub. Date: Oct. 20, 2005

(54) Information recording method, information recording device, information recording medium

(76) Inventor: Koubun Sakagami, Kanagawa (JP)

Correspondence Address: DICKSTEIN SHAPIRO MORIN & OSHINSKY LLP, 2101 L Street, NW, Washington, DC, 20037, US

(21) Appl. No.: 11/078,548

(22) Filed: Mar. 14, 2005

(30) Foreign Application Priority Data
Mar. 15, 2004 (JP) 2004-072671

(51) Int. Cl. H04N 7/26

(52) U.S. Cl. 386/112

(57) ABSTRACT

An information recording method whereby information data are recorded in an information recording medium includes the steps of: adding address data to the information data of a specific amount of units so that binary data are formed, converting the binary data to multi-level data, and adding other multi-level data for detecting the address data; and thereby the information data are recorded.

### BACKGROUND OF THE INVENTION

1. Field of the Invention

The present invention relates to information recording methods, information recording devices, and information recording media, and more specifically, to an information recording method and information recording device wherein information is recorded by light or the like, and an information recording medium.

2. Description of the Related Art

A technology wherein a synchronizing signal having a different signal pattern is added to a data block consisting of main data and a sector address in order to determine whether the added part is the top of the sector address, is disclosed in the Japanese Patent No. 2882302.

However, in a case where information is recorded in an information recording medium such as an optical disk, there are plural patterns of the synchronizing signal and therefore it is difficult to detect the synchronizing signal. Particularly, it is necessary to detect the synchronizing signal by a PLL (Phase Locked Loop) circuit for generating a clock synchronized with the data, other than for the purpose of reading out the address of the information recording medium. Hence, it is preferable that the synchronizing signal have the same pattern.

In addition, in the technology disclosed in the Japanese Patent No. 2882302 (See FIG. 5 and FIG. 6 of Japanese Patent No. 2882302), the sector address is written in one sector plural times and thereby a data structure having large redundancy is formed.

### SUMMARY OF THE INVENTION

Accordingly, it is a general object of the present invention to provide a novel and useful information recording method, information recording device, and information recording medium.

Another and more specific object of the present invention is to provide an information recording method, information recording device, and information recording medium, whereby a reading process of address data can be implemented easier than in the conventional art.

The above object of the present invention is achieved by an information recording method whereby information data are recorded in an information recording medium, including the steps of:
adding address data to the information data of a specific amount of units so that binary data are formed;
converting the binary data to multi-level data; and
adding other multi-level data for detecting the address data; and thereby the information data are recorded.

The above object of the present invention is also achieved by an information recording device configured to record information data in an information recording medium by using a method, the method including the steps of:
adding address data to the information data of a specific amount of units so that binary data are formed;
converting the binary data to multi-level data; and
adding other multi-level data for detecting the address data; and thereby the information data are recorded.

The above object of the present invention is also achieved by an information recording medium where information data are recorded by using a method, the method including the steps of:
adding address data to the information data of a specific amount of units so that binary data are formed;
converting the binary data to multi-level data; and
adding other multi-level data for detecting the address data; and thereby the information data are recorded.

According to the above-mentioned inventions, the binary data formed by the information data of the specific amount of units such as sector units and the address data such as the sector address are transformed to multi-level data, and the multi-level data for detecting the address data are added. Therefore, it is possible to easily implement a reading process of the address data.

Other objects, features, and advantages of the present invention will become more apparent from the following detailed description when read in conjunction with the accompanying drawings.

### BRIEF DESCRIPTION OF THE DRAWINGS

FIG. 1 is a data structural view of a sector consisting of 2 KB user data, their addresses, and others;

FIG. 2 is a table showing kinds of the data included in the sector and the numbers of bytes of the data;

FIG. 3 is a data structural view (ECC block) wherein error correction data are added to data of 64 sectors;

FIG. 4 is an explanation view showing a result of a line of PO being interleaved;

FIG. 5 is a data structural view when the data block (530 words×280 lines) shown in FIG. 4 is transformed to multi-level data so as to be recorded in an optical disk;

FIG. 6 is a data structural view for explaining a modified example of an information recording method explained with reference to FIG. 1 and others;

FIG. 7 is a table showing kinds and amount of data regarding sector data including user data of 2 KB unit and address information showing an address of a sector unit;

FIG. 8 is a view for explaining a case where data of 8 bits×9 lines are converted to data of 6 bits×12 lines and error correction is implemented by using address ECC data;

FIG. 9 is a data structural view of sector data;

FIG. 10 is a data structural view (ECC block) wherein error correction data are added to data of 64 sectors;

FIG. 11 is an explanation view showing a result of a PO data line being interleaved;

FIG. 12 is a data structural view when the data block (476 words×218 lines) shown in FIG. 11 is transformed to multi-level data so as to be recorded in an optical disk;

FIG. 13 is a data structural view for explaining a modified example of an information recording method explained with reference to FIG. 7 and others; and

FIG. 14 is a block diagram for explaining a structure of an information recording device of an embodiment of the present invention.

### DETAILED DESCRIPTION OF THE PREFERED EMBODIMENTS

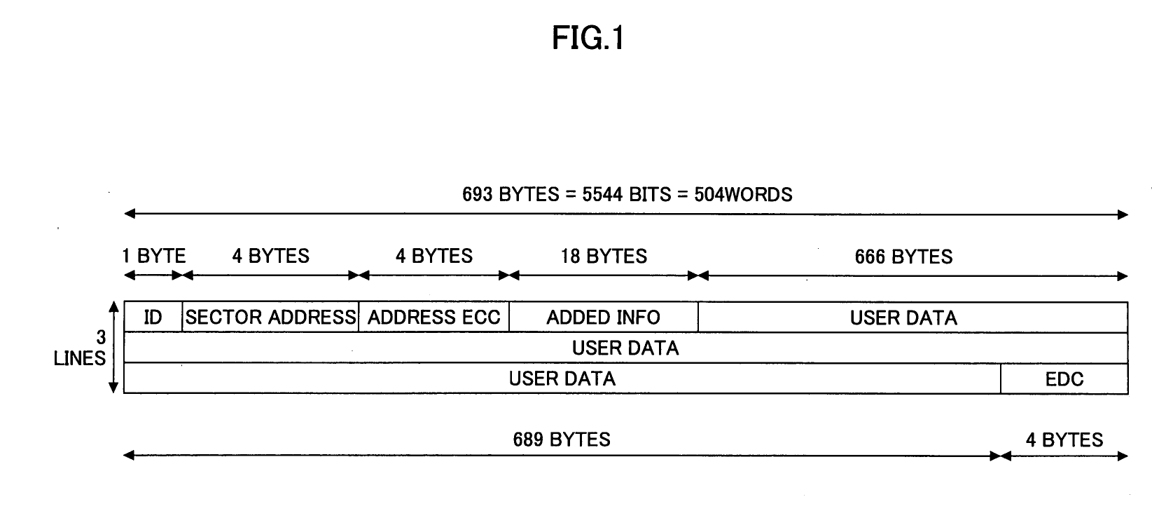

A description of the present invention and details of drawbacks of the related art are now given, with reference to FIG. 1 through FIG. 14.

First, an information recording method of an embodiment of the present invention is discussed.

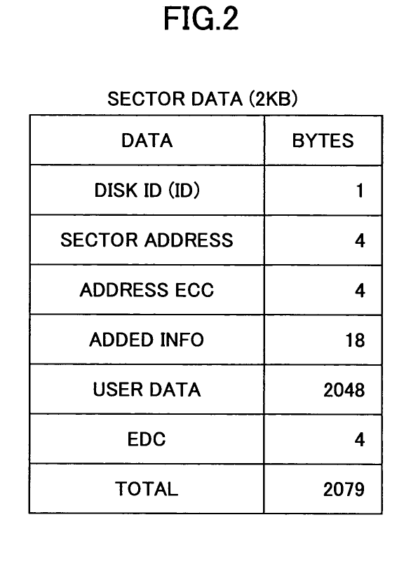

Information is recorded in an information recording medium such as an optical disk by this information recording method. In the following, recording in the optical disk is discussed as an example of this embodiment. FIG. 1 is a data structural view of a sector consisting of 2 KB (more specifically, 2048 bytes) of user data, their addresses, and others. FIG. 2 is a table showing kinds of the data included in the sector and the numbers of bytes of the data. Disk identification data (ID) are information data for identifying whether an optical disk as an information recording medium is reading only or rewriteable, whether the recording layer structure of the optical disk is single-layer or multi-layer, or the like. A sector address is address data on the disk and assigned to the 2 KB user data. An address ECC (Error Correction Code) is error correction data added to the address data of 4 bytes. The address ECC data are formed by the disk ID data, the sector address data, and a Reed Solomon code RS (9, 5, 5) wherein 8 bits are used for 1 word.

Added information is data for showing future extensibility and added information to user data such as user information, manufacturer information, copyright protection, or the like. The user data are data forming contents such as image or voice data having 2 KB, computer software, or the like. EDC (Error Detection Code) is error detection data added to the ID, the sector address, the address ECC, added information, and the user data in one sector. Here, the above-mentioned 2079 bytes are called sector data.

As shown in FIG. 1, the sector data are formed as 693 bytes×3 lines. The amount of bytes for one line is 5544 bits and the amount of words for one line is 504 words, as calculated by “693 bytes×8 bits=5544 bits=11 bit×504 words”.

Binary data having 11 bits are modulated to four eight-level data items so that a multi-level recording is implemented in the optical disk. Therefore, a state where one line of the sector data is formed by word data having 11 bits is proper for converting to the multi-level data.

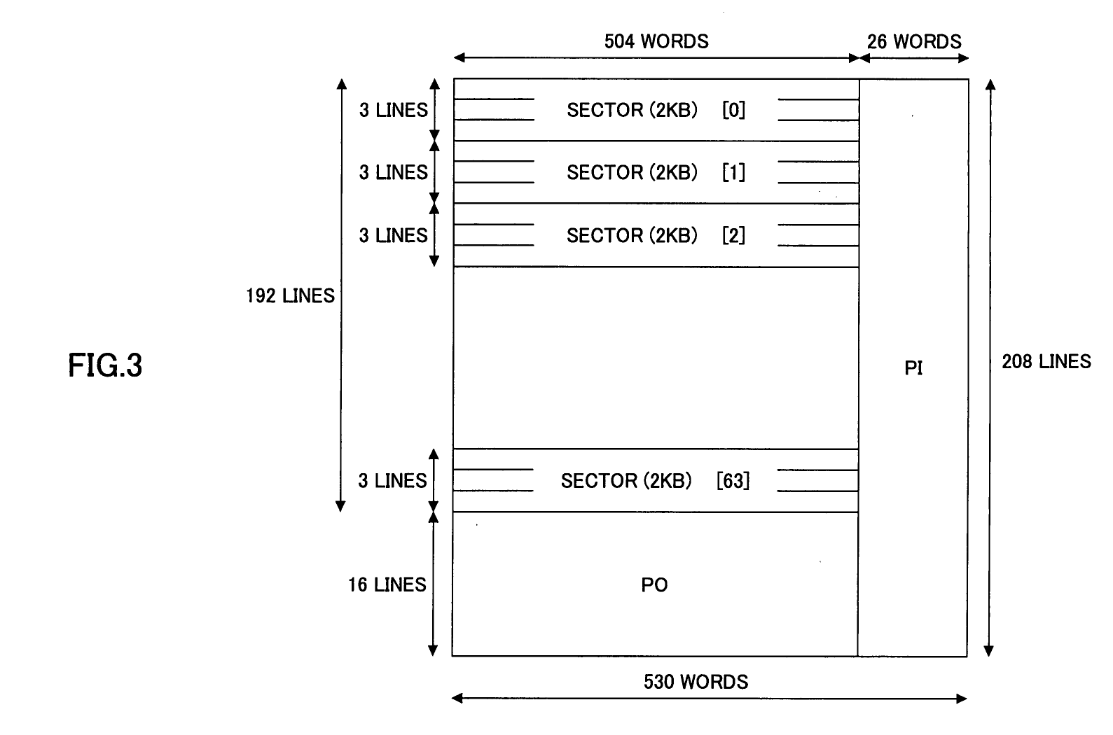

FIG. 3 is a data structural view (ECC block) wherein error correction data are added to data of 64 sectors. First, an outer parity code (PO) is added in a vertical direction in FIG. 3. The PO is formed by using a Reed Solomon code RS (208, 192, 17). After that, an inner parity code (PI) is added in a horizontal direction in FIG. 3. The PI is formed by using a Reed Solomon code RS (530, 504, 27).

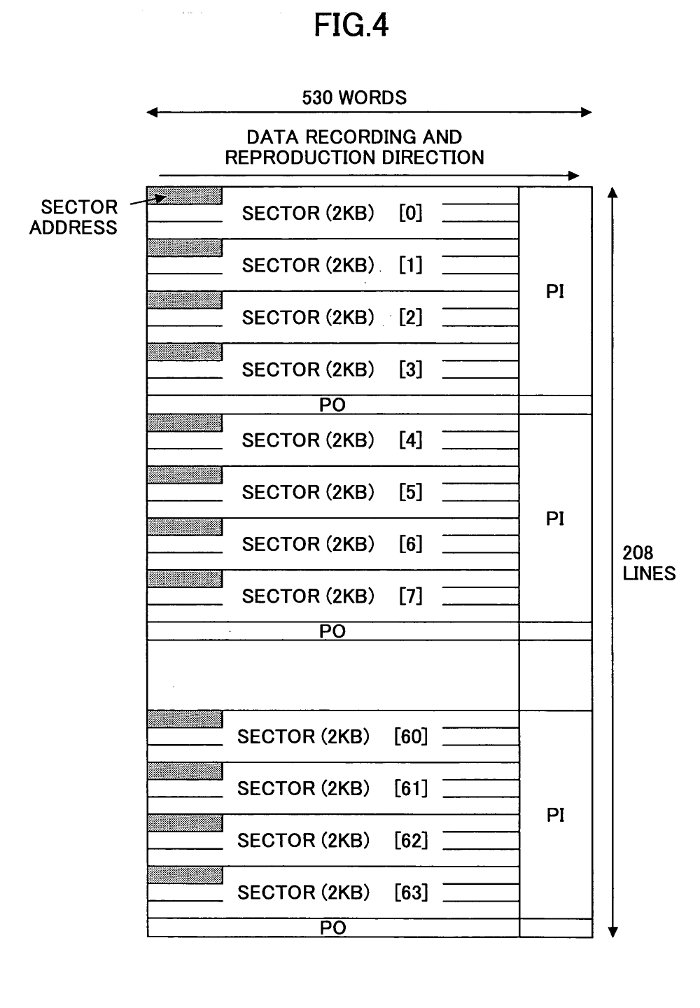

FIG. 4 is an explanation view showing a result of lines of PO being interleaved. There are 16 lines of PO (including PI) added, one for each 4 sectors (12 lines) one line by one line. Because of this, a line including the sector address appears every three or four lines so that reading efficiency of the address at the time for accessing the data is improved. As shown in FIG. 4, data are recorded in or reproduced from the information recording medium such as the optical disk in a horizontal direction in order.

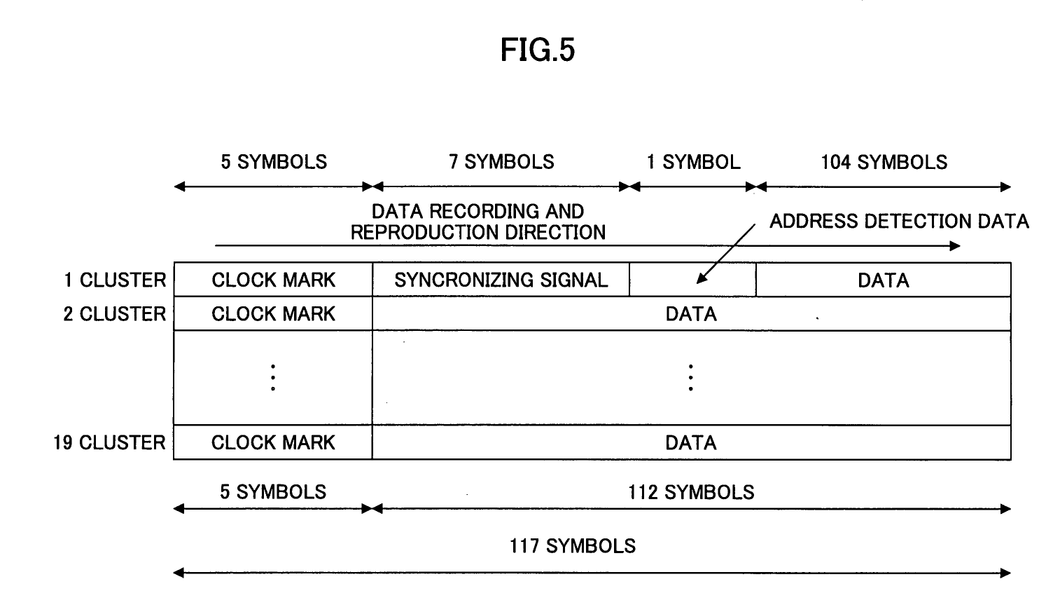

FIG. 5 is a data structural view when the data block (530 words×208 lines) shown in FIG. 4 is transformed into multi-level data so as to be recorded in an optical disk. This is the data structure at the time when one line of data is recorded. That is, binary data having 11 bits (1 word) are modulated to four eight-level data items (having a level from 0 through 7) and recorded. Hereinafter, one multi-level data is called a symbol. Clock marks, synchronizing signals, and address detection data, described below, are added to the modulated multi-level data and recorded.

| | | | |
|---|---|---|---|
| Clock mark | = | “00700” | |
| Synchronizing signal | = | “0007777” | |
| Address detection data | = | “0”: | First line of the sector data |
| | | | (Sector address data exists) |
| | | “3”: | Second line of the sector data |
| | | “5”: | Third line of the sector data |
| | | “7”: | PO data line |

The synchronizing signal is a signal for detecting an end of every single line of the data block (530 words×208 lines) shown in FIG. 4. The clock mark is a signal for forming a clock signal synchronizing the multi-level data. The address detection data are data for detecting which line of the three lines of the sector data is this one line of data or whether this one line of data is the PO data line.

Since the binary data having 530 words are modulated to four symbols of eight-level data for every one word (11 bits), the number of symbols of the modulated multi-level data are shown as “530 words×4 symbols=2120 symbols”.

Since the synchronizing signal and the address detection data are added to this, the number of symbols of all of the multi-level data are shown as “2120 symbols+8 symbols=2128 symbols”.

A data structure shown in FIG. 5 is obtained by adding the clock mark (the multi-level data of 5 symbols) to this multi-level data series for every 112 symbols. Hereinafter, this is called one frame. The data block (530 words×208 lines) shown in FIG. 4 has 208 frames. In the 1 frame, data of one line of 117 symbols starting from the clock mark are called a cluster. As shown in FIG. 5, data are recording in or reproduced from the information recording medium such as the optical disk in a horizontal direction in order.

When the data in the optical disk are accessed, it is necessary to read out the sector address so that the data block shown in FIG. 4 is detected. First, the synchronizing signal is detected and the end of one line of data is detected. Next, the clock mark is detected from the detected synchronizing signal, and a clock signal synchronized to the multi-level data “7” by the PLL (Phase Locked Loop) circuit, is formed.

After that, the address detection data are read out. In a case where the address detection data have a level of “0”, the sector address of this line is read out. This sector address is obtained by detecting the multi-level data, converting to the binary data, and then correcting errors using the address ECC. In a case where the address detection data are “3”, “5”, or “7”, it is possible to predict when “0” appears and therefore to complement a case where reading error occurs.

Thus, in the information recording method of this embodiment, in a case where the user data of the sector unit as the information data are recorded in the optical disk as the information recording medium, the sector address as the address data is added to the user data, and these binary data are converted to the multi-level data, so that the information is recorded. Therefore, it is possible to easily read out the sector address by using the address detection data. Furthermore, the address detection data are multi-level data, eight-level data in this example. Since four-level recording that uses four kinds, namely “0”, “3”, “5”, and “7”, is implemented, an error rate at the reading time can be made low and it is possible to improve reliability of detection of the address data.

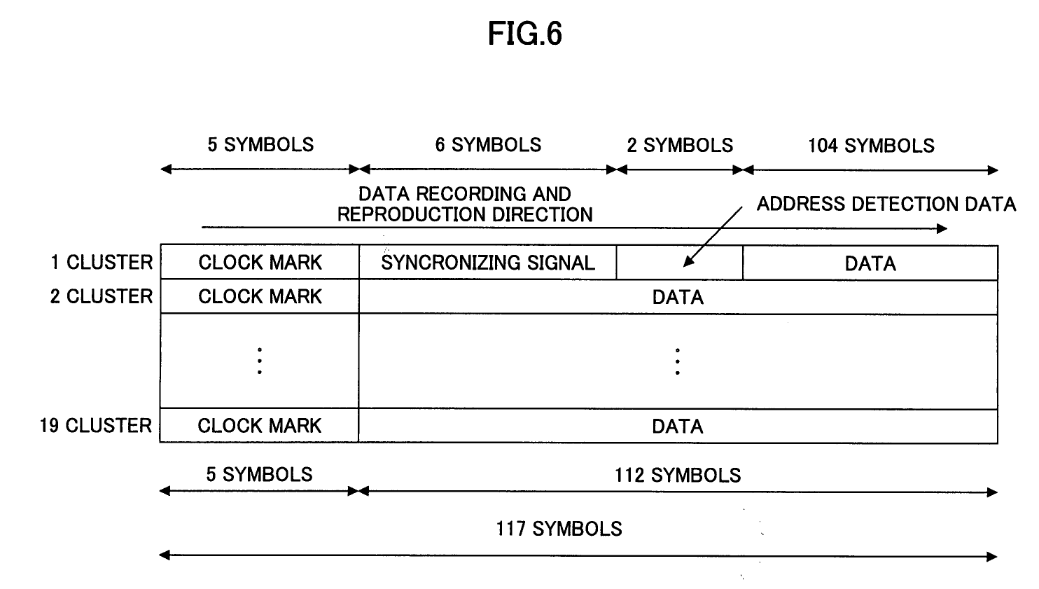

FIG. 6 is a data structural view for explaining a modified example of the information recording method explained with reference to FIG. 1 through FIG. 5. The synchronizing signal and address detection data in FIG. 5 are modified as follows.

| | | | |
|---|---|---|---|
| Synchronizing signal | = | “007777” | |
| Address detection data | = | “00”: | First line of the sector data |
| | | | (Sector address data exists) |
| | | “33”: | Second line of the sector data |
| | | “55”: | Third line of the sector data |
| | | “77”: | PO data line |

In this case, the address detection data have the same levels for 2 symbols running so that recording density is made small. Therefore, an error rate at the reading time can be made low and it is possible to improve reliability of detection of the address data.

Next, a second embodiment of the present invention is discussed.

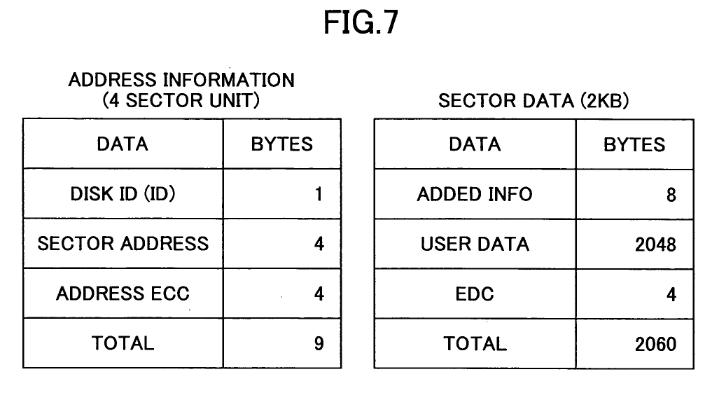

Information is recorded in an information recording medium such as an optical disk by the information recording method of this second embodiment of the present invention. In the following, recording in the optical disk is discussed as an example of this embodiment. FIG. 7 is a table showing kinds and amounts of data regarding sector data including user data of a 2 KB unit and address information showing an address of a sector unit. The sector data are formed by user data, added information, and EDC. The address information is formed by disk identification (ID) data, a sector address, and address ECC. In this example, since the address information is added at a four-sector unit, a sector address of an integer multiple of four, a representative address of the four sectors, is used as the address information. The EDC in the second embodiment is error detection data added to the added information and the user data.

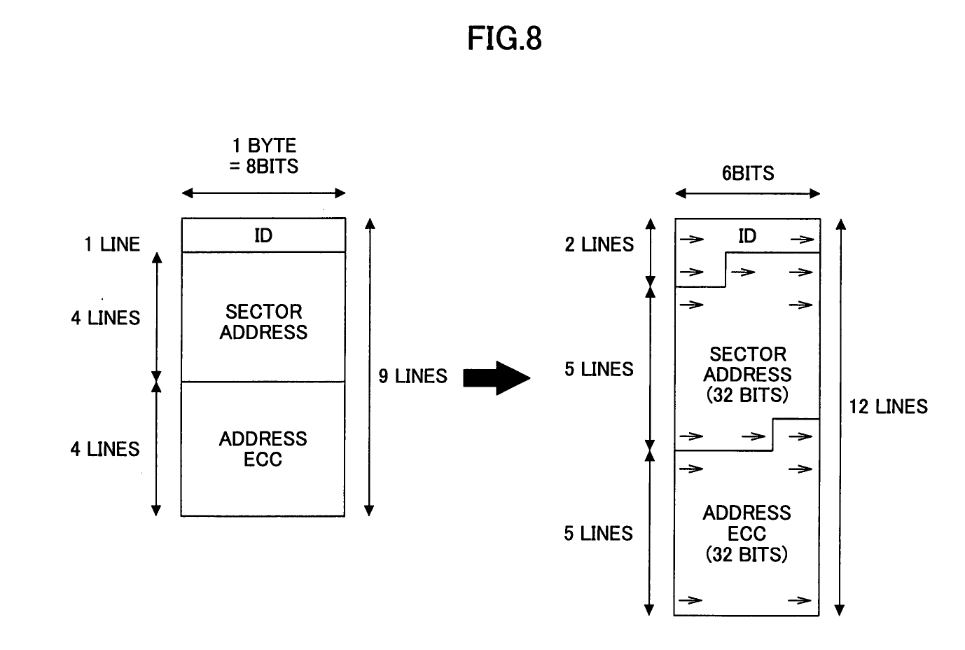

FIG. 8 is a data structural view of the address information. Data of 8 bits×9 lines are converted to data of 6 bits×12 lines and error correction is implemented by using address ECC data.

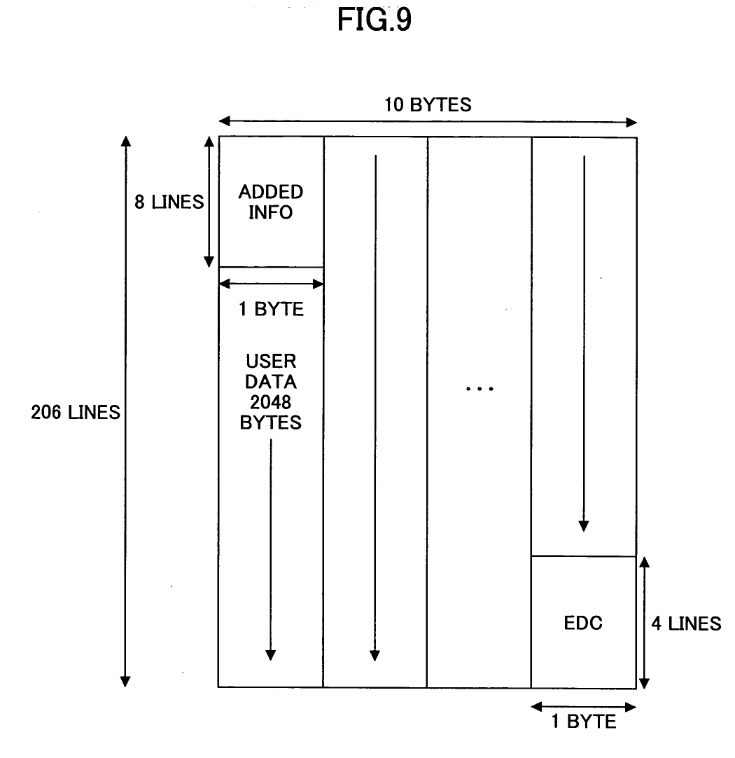

FIG. 9 is a data structural view of sector data. Data of one sector are formed as 10 bytes×206 lines. Respective data are arranged in order in a vertical direction in FIG. 9.

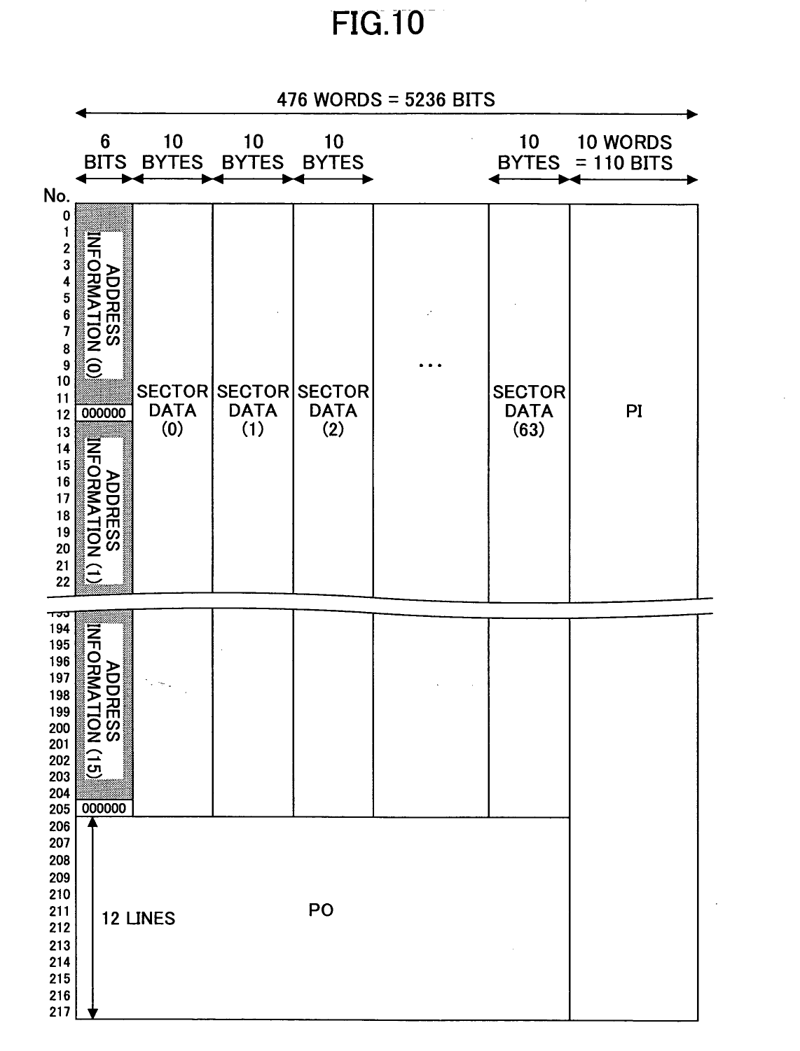

FIG. 10 is a data structural view (ECC block) wherein error correction data are added to data of 64 sectors. First, an outer parity code (PO) is added in a vertical direction in FIG. 10. The PO is formed by using a Reed Solomon code RS (218, 206, 13). After that, an inner parity code (PI) is added in a horizontal direction in FIG. 10. The PI is formed by using a Reed Solomon code RS (476, 466, 11). In this data structure, data of a single horizontal line have an amount of “6 bits+10 bytes (80 bits)×64 sectors+10 words (110 bits)=5236 bits=11 bits×476 words”, wherein one word has 11 bits.

One group of the address information is formed by 12 lines. Since one address information item exists per 4 sectors, 16 address information items exist in one ECC block for data of 64 sectors. In order to arrange them to 206 lines, invalidation data (000000) having 6 bits are irregularly added. The number of the added invalidation data item is shown as “206-12×16=14”.

For example, 14 invalidation data items are arranged in 12th, 25th, 38th, 51st, 76th, 89th, 102nd, 115th, 128th, 141st, 154th, 179th, 192nd, and 205th lines among 206 lines (Oth line through 205th line).

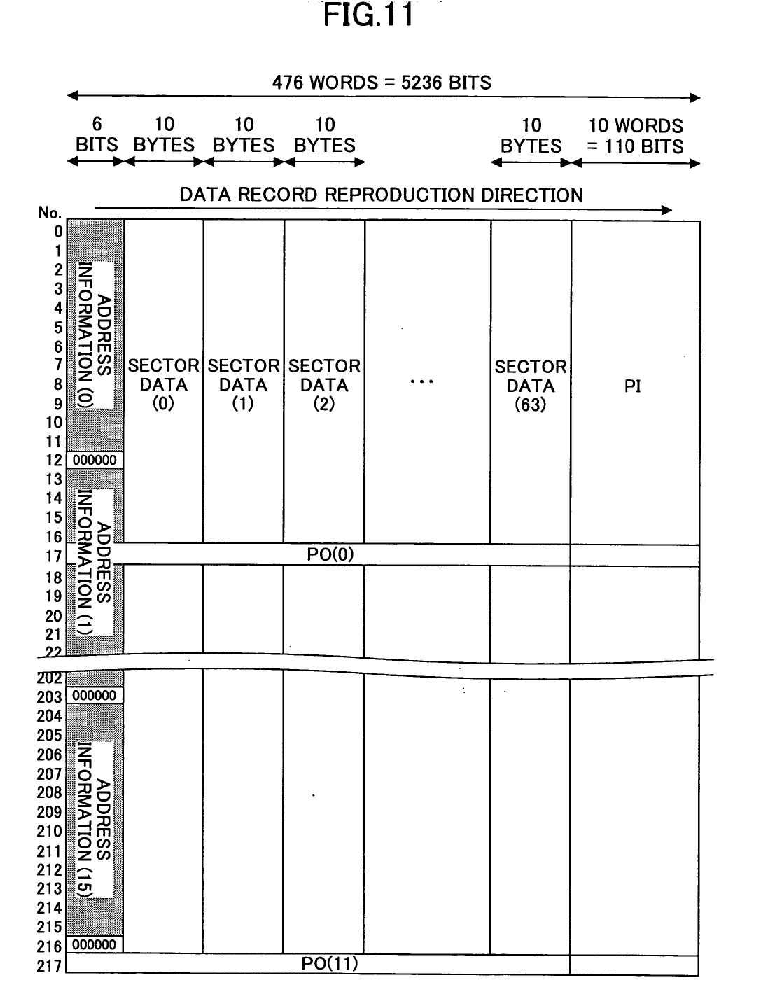

FIG. 11 is an explanation view showing a result of a PO data line being interleaved. Since the PO data lines (including PI included in the respective lines) of 12 lines are arranged in 218 lines in a substantially equivalent state, a slightly irregular interleaving is formed. An example of the line numbers (0 line through 217th line) of the PO data lines is “17, 35, 54, 72, 90, 108, 126, 144, 163, 181, 199, 217”.

Thus, the lines not including the address information are dispersed and therefore the reading efficiency of the address at the time of accessing data is improved.

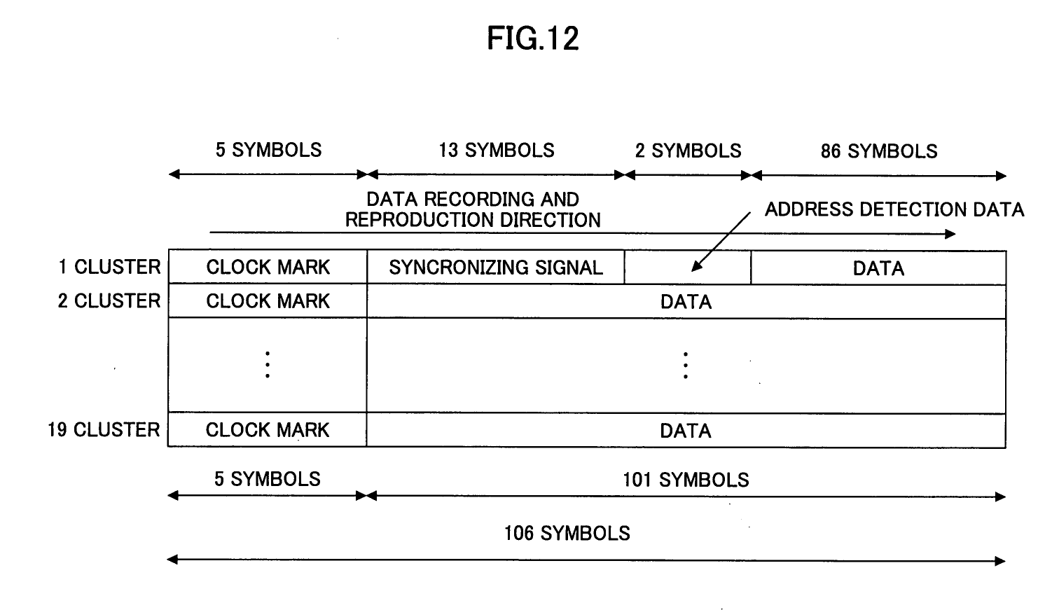

FIG. 12 is a data structural view when the data block (476 words×218 lines) shown in FIG. 11 is transformed to multi-level data so as to be recorded in an optical disk. This is the data structure at the time when one line of data is recorded. Data of one line of the data block shown in FIG. 11 is recorded and reproduced in a horizontal direction as shown in FIG. 11. The data are modulated to four eight-level symbols and recorded in the optical disk, in a state where data having 11 bits (one word) is one unit. The clock mark, synchronizing signal, and address detection data described below are added to the modulated multi-level data and recorded.

| | | | |
|---|---|---|---|
| Clock mark | = | “00700” | |
| Synchronizing | = | “0000007777777” | |
| signal | | | |
| Address detection | = | “00”: | First line of the address |
| data | | | information |
| | | “03”: | Second line of the address |
| | | | information |
| | | “05”: | Third line of the address |
| | | | information |
| | | “07”: | Fourth line of the address |
| | | | information |
| | | “30”: | Fifth line of the address |
| | | | information |
| | | “33”: | Sixth line of the address |
| | | | information |
| | | “35”: | Seventh line of the address |
| | | | information |
| | | “37”: | Eighth line of the address |
| | | | information |
| | | “50”: | Ninth line of the address |
| | | | information |
| | | “53”: | Tenth line of the address |
| | | | information |
| | | “55”: | Eleventh line of the address |
| | | | information |
| | | “57”: | Twelfth line of the address |
| | | | information |
| | | “70”: | Invalid data line of the |
| | | | address information |
| | | “73”: | Not used |
| | | “75”: | Not used |
| | | “77”: | PO data line |

The synchronizing signal and the clock mark are added for the same purpose as the above-discussed information recording method. The address detection data are data for detecting which line of 12 lines including the address information is the one line of data, whether the one line of data includes the invalidation data of the address information, or whether the one line of data is the PO data line.

Since the binary data having 476 words are modulated to four symbols of eight-level data for every one word (11 bits), the number of symbols of the modulated multi-level data are shown as “476 words×4 symbols=1904 symbols”.

Since the synchronizing signal and the address detection data are added to this, the number of symbols of all of the multi-level data are shown as “1904 symbols+15 symbols=1919 symbols”.

A data structure shown in FIG. 12 is obtained by adding the clock mark (the multi-level data of 5 symbols) to this multi-level data series for every 101 symbols. Hereinafter, this is called one frame. The data block (476 words×218 lines) shown in FIG. 11 has 218 frames. In the 1 frame, data of one line of 106 symbols starting from the clock mark is called a cluster. As shown in FIG. 5, data are recorded in or reproduced from the information recording medium such as the optical disk in a horizontal direction in order.

When the data on the optical disk are accessed, it is necessary to read out the sector address so that the data block shown in FIG. 11 is detected. First, the synchronizing signal is detected and the end of one line of data is detected. Next, the clock mark is detected from the detected synchronizing signal, and a clock signal that is synchronized to the multi-level data of a symbol “7” in the clock mark, is generated by the PLL (Phase Locked Loop) circuit.

After that, the address detection data are read out. In a case where the address detection data shows any of 12 lines of the address information, 6 bits of the address information are saved and the address information of 12 lines (72 bits) is stored. This address information is obtained by detecting the multi-level data and converting to the binary data. Then, as shown in FIG. 8, data of 6 bits×12 lines are converted to data of 8 bits×9 lines, and the error correction is done by using the address ECC data. Then the sector address is read out. Since 12 lines of the address information, the invalidation data line, and the PO data line are detected by the address detection data and therefore the timing of the 12 lines of the address information can be predicted, it is possible to complement a case where reading error occurs.

Thus, in the information recording method of this embodiment, in a case where the user data of the sector unit as the information data are recorded in the optical disk as the information recording medium, the sector address as the address data is added to the user data, and these binary data are converted to the multi-level data, so that the information is recorded as the address detection data that is the multi-level data to detect the sector address data. Therefore, it is possible to easily read out the sector address by the address detection data. Furthermore, the address detection data are multi-level data, eight-level data in this example. Since four-level symbol recording that uses four kinds, namely “0”, “3”, “5”, and “7”, is implemented, an error rate at the reading time can be made low and it is possible to improve reliability of detection of the address data. Furthermore, in this information recording method, since one address information item is added for each four-sector unit, it is possible to make the redundancy of the data structure low.

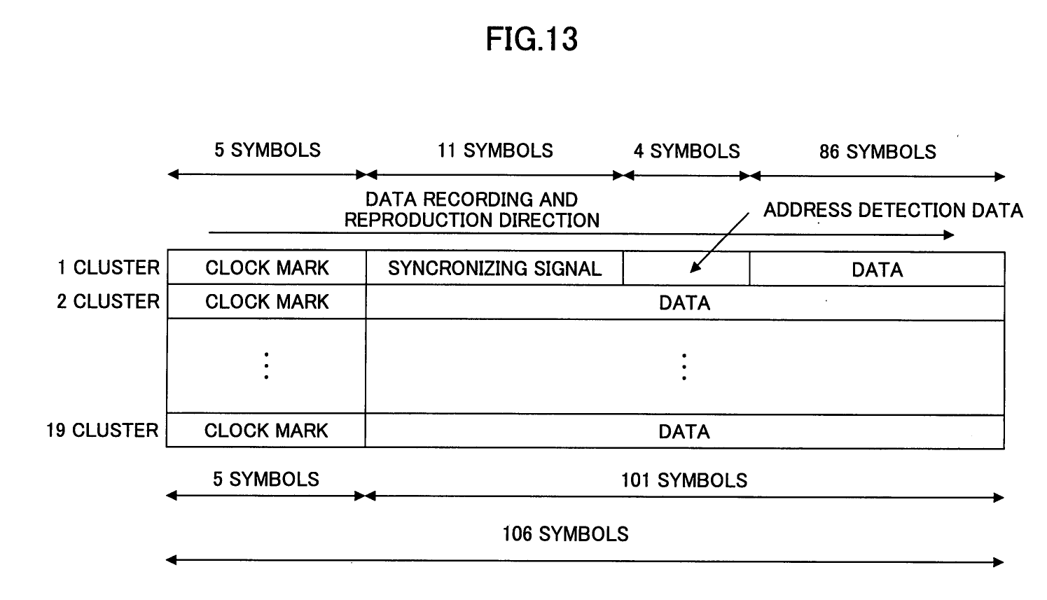

FIG. 13 is a data structural view for explaining a modified example of an information recording method explained with reference to FIG. 7 through FIG. 12. The synchronizing signal and address detection data in FIG. 12 are modified as follows.

| | | | |
|---|---|---|---|
| Synchronizing | = | “00000777777” | |
| signal | | | |
| Address detection | = | “0000”: | First line of the address |
| data | | | information |
| | | “0033”: | Second line of the address |
| | | | information |
| | | “0055”: | Third line of the address |
| | | | information |
| | | “0077”: | Fourth line of the address |
| | | | information |
| | | “3300”: | Fifth line of the address |
| | | | information |
| | | “3333”: | Sixth line of the address |
| | | | information |
| | | “3355”: | Seventh line of the address |
| | | | information |
| | | “3377”: | Eighth line of the address |
| | | | information |
| | | “5500”: | Ninth line of the address |
| | | | information |
| | | “5533”: | Tenth line of the address |
| | | | information |
| | | “5555”: | Eleventh line of the address |
| | | | information |
| | | “5577”: | Twelfth line of the address |
| | | | information |
| | | “7700”: | Invalid data line of the |
| | | | address information |
| | | “7733”: | Not used |
| | | “7755”: | Not used |
| | | “7777”: | PO data line |

In this case, the address detection data have the same levels for 2 symbols running so that recording density is made small. Therefore, an error rate at the reading time can be made low and it is possible to improve reliability of detection of the address data.

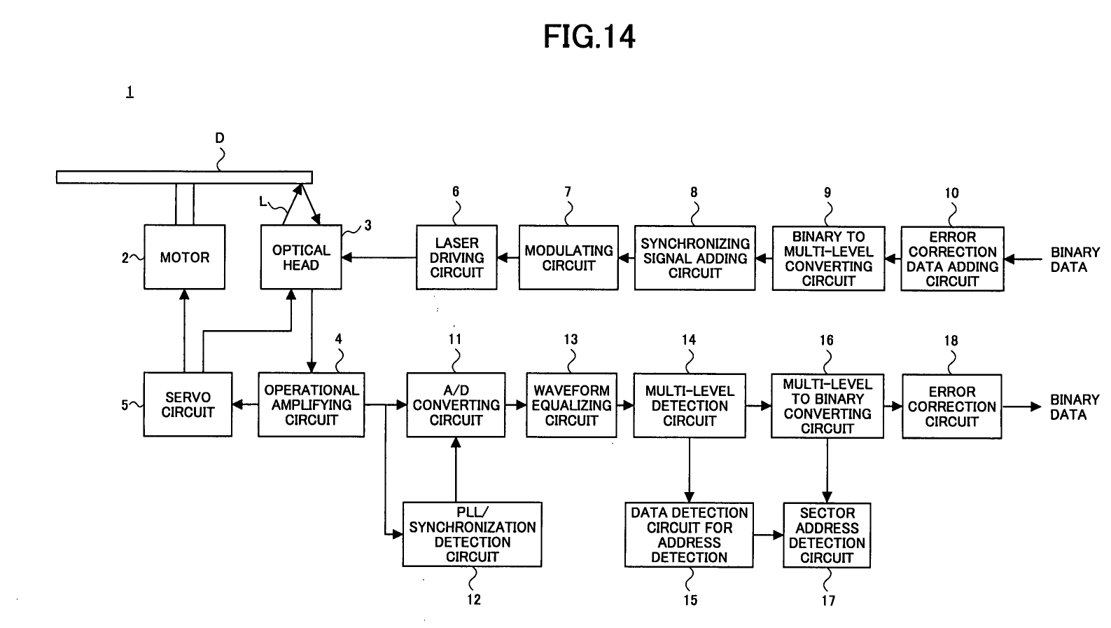

Next, a third embodiment of the present invention, namely an information recording device by which the above-discussed information recording methods are implemented, is discussed. FIG. 14 is a block diagram for explaining a structure of an information recording device 1 of an embodiment of the present invention. The information recording device 1 is a device whereby information is recorded in an optical disk D as the information recording medium.

In FIG. 14, marks are recorded to spiral or concentric tracks formed in an optical disk D. The tracks slightly meander at a constant period.

A motor 2 rotates the optical disk D. An optical head 3 irradiates a spot of laser light on the optical disk D for recording marks thereto and scans the marks with a laser light spot L for outputting electric signals.

An operational amplifying circuit 4 subjects the electric signals output from the optical head 3 to an operational amplification, so as to output reproduction signals corresponding to the marks on the optical disk D, focus error signals for indicating a focus state of the laser light spot L with respect to a recording surface of the optical disk D, tracking error signals for indicating a tracking state of the laser light spot L with respect to the tracks of the optical disk D, and/or signals corresponding to meandering movements of the tracks.

A servo circuit 5, in accordance with the foregoing signals, matches the focus of the laser light spot L on the recording surface of the optical disk D, enables the tracks to be scanned appropriately, and/or allows the optical disk D to be rotated at a steady linear or angular rate in accordance with the signals.

A laser drive circuit 6 outputs signals for recording the marks on the optical disk D by the laser light spot L in accordance with the signals output from a modulating circuit 7.

The modulating circuit 7 outputs signals which indicate sizes of the marks corresponding to input multi-level data and blank spaces (spaces, at which no information is recorded, correspond to zero data of multi-level data). A synchronization signal adding circuit 8 adds synchronizing signals for indicating sections of prescribed amounts of data. A binary to multi-level converting circuit 9 converts input binary data (11 bits) into multi-level data (eight-level data of 4 symbols).

An error correction data adding circuit 10 adds data for error-correcting to the input data, namely performing data-processing by the above-discussed information recording method.

An A/D converting circuit 11 converts reproduction signals from the operational amplifying circuit 4 into digital signals. A PLL (Phase Locked Loop) and synchronization detection circuit 12 outputs clock signals synchronizing with the multi-level data. A waveform equalizing circuit 13 equalizes a waveform. A multi-level detection circuit 14 detects the multi-level data.

A data detection circuit 15 for detecting addresses detects the address detection data so as to output signals indicating line data wherein the sector address or the address information exists. A multi-level to binary converting circuit 16 converts multi-level data detected by the multi-level detection circuit into binary data. A sector-address detection circuit 17 stores data regarding an address of the line data where the sector address or the address information exists, corrects error using the address ECC data, reads the sector address, and detects the ECC block. An error correction circuit 18 corrects errors using the error correction data.

Although not illustrated in FIG. 14, the information recording device also includes a searching unit which moves the optical head 3 in a radial direction of the optical disk D to thereby search for data on the optical disk D. Furthermore, illustrations of, for example, an interface circuit to be used as an information memory apparatus for a computer, and/or a microprocessor for controlling an entire operation of the information recording device have been omitted. A DVD-RW type disk is used as the optical disk D and a laser diode or the like having a laser light wave length of 650 nm is used as the optical head 3. A phase change type optical disk which corresponds to a blue laser suitable for a higher density recording and a laser wave length (for example, 405 nm) of the blue laser can be used as the optical disk D.

An operation of the information recording device 1 according to the present embodiment is next described. First, an operation of converting binary data into multi-level data and then recording information in the optical disk D is described. The binary data are added and the added information data and EDC data are added every 2 KB of user data as discussed with reference to FIG. 1 or FIG. 8 and FIG. 9. In addition, the disk identification data, sector address data, and the address ECC data are formed. As discussed with reference to FIG. 3 or FIG. 10, the data of 64 sectors are input to a memory (wherein one word has 11 bits, not shown) in the data adding circuit for error-correcting.

After that, PO and PI data is formed by calculation of the Reed Solomon code so as to be input to the memory. In the interleaving process discussed with reference to FIG. 4 or FIG. 11, when the lines of the data are output from the memory, data of one line including the PO data may be output in interleaving order.

Next, the binary data of 11-bit units are converted to eight-level data of 4 symbols by the binary to multi-level converting circuit 9. Then, by the synchronizing signal adding circuit 8, the synchronizing signal, the address detection data, and the clock mark are added to the data for every one line. As a result of this, the data indicated in FIG. 5, FIG. 6, FIG. 12, or FIG. 13 are output. Next, in order to record the mark corresponding to the levels of the multi-level data in the optical disk D, a signal driving the laser is formed by the modulating circuit 7. Then the mark is recorded in the optical disk D by the optical head 3.

Next, a case where the multi-level signal is read from the optical disk D, and the multi-level detection is performed so that the multi-level data are output as binary data, is discussed. A laser light having a designated strength is irradiated on the optical disk D by the optical head 3 and a reflection light of the laser light is photo-electrically converted so that an electric signal is obtained. The obtained signal is input to the operational amplifying circuit 4, the optical disk D is stably rotated by the servo circuit 5, tracking or focus control of the optical head 3 is performed, and thereby the multi-level signal is reproduced. The synchronizing signal is detected from the reproduced multi-level signal by the PLL and the synchronizing detection circuit 12 so that the clock synchronizing the multi-level data is produced by the PLL circuit. Digital data having the multi-level data are obtained by the produced clock via the A/D converting circuit 11. After that, waveform equalizing is performed by the waveform equalizing circuit 13, the multi-level data are detected by the multi-level detection circuit 14, and the detected multi-level data are converted to the binary data by the multi-level to binary converting circuit 16.

Then, by using the synchronizing signal detected by the PLL and the synchronization detection circuit, the address detection data of the frame are detected by the data detection circuit 15. Depending on the level of the detected address detection data, a signal indicating the frame including the sector address and the address information is output to the sector address detection circuit 17. In the sector address detection circuit 17, the data regarding the address of the line data where the sector address or the address information exists are stored, the error correction is performed by the address ECC data, the sector address is read out, and the top address of the ECC block is detected so that a signal indicating start of input of the binary data to the error correction circuit 18 is output.

In the error correction circuit 18, the data of the ECC block are input to the memory (wherein one word has 11 bits, not shown) in the data adding circuit for error-correcting. Since the PO data lines are interleaved, to reverse the interleaving, the address is switched to make the data structure as shown in FIG. 3 or FIG. 10, and the data are input to the memory. After that, by using the PO and PI data, the error is detected and corrected and the corrected binary data are output.

According to the information recording device discussed above, since the address detection data are added, it is possible to easily read out the sector address. In addition, since the data process is implemented by the error correction data adding circuit 10 so that a single sector address is added every four-sector unit, it is possible to make the redundancy of the data structure short. Furthermore, by the synchronizing signal adding circuit 8, the data structures shown in FIG. 5, FIG. 6, FIG. 12, or FIG. 13 are made and the address detection data are recorded as four-level symbols, it is possible to improve the reliability of the detection of the address data. In addition, in a case of a data structure shown in FIG. 6 or FIG. 13, the address detection data has the same levels for 2 symbols running so that a recording density is made small. Therefore, an error rate at the reading time can be made low and it is possible to improve reliability of detection of the address data.

Furthermore, in the optical disk D of this embodiment as the information recording medium where the above-mentioned recording is performed, since the address detection data are added to the information formed by the user data of the sector unit and the sector address, it is possible to easily read the sector address. In addition, since a single sector address is added every four-sector unit, it is possible to make the redundancy of the data structure short. Furthermore, since the address detection data are recorded as four-level symbols so that count of levels of recorded multi-level data is decreased, it is possible to improve the reliability of the address data. In addition, in a case of the data structure shown in FIG. 6 or FIG. 13, the address detection data have the same levels for 2 symbols running so that recording density is made small. Therefore, an error rate at the reading time can be made low and it is possible to improve reliability of detection of the address data.

The present invention is not limited to the above-discussed embodiments, but variations and modifications may be made without departing from the scope of the present invention.

This patent application is based on Japanese Priority Patent Application No. 2004-72671 filed on Mar. 15, 2004, the entire contents of which are hereby incorporated by reference.

1. An information recording method whereby information data are recorded in an information recording medium, comprising the steps of:
adding address data to the information data of a specific amount of units so that binary data are formed;
converting the binary data to multi-level data; and
adding other multi-level data for detecting the address data; and thereby the information data are recorded.

2. The information recording method as claimed in claim 1,
wherein single address data are added to a plurality of the information data of the specific amount of units.

3. The information recording method as claimed in claim 1,
wherein the count of levels of the other multi-level data for detecting the address data is less than the count of levels of the multi-level data.

4. The information recording method as claimed in claim 1,
wherein a recording density of the other multi-level data for detecting the address data is lower than a recording density of the multi-level data.

5. An information recording device configured to record information data in an information recording medium by using a method, the method comprising the steps of:
adding address data to the information data of a specific amount of units so that binary data are formed;
converting the binary data to multi-level data; and
adding other multi-level data for detecting the address data; and thereby the information data are recorded.

6. The information recording device as claimed in claim 5,
wherein single address data are added to a plurality of the information data of the specific amount of units.

7. The information recording device as claimed in claim 5,
wherein the count of levels of the other multi-level data for detecting the address data is less than the count of levels of the multi-level data.

8. The information recording device as claimed in claim 5,
wherein a recording density of the other multi-level data for detecting the address data is lower than a recording density of the multi-level data.

9. An information recording medium where information data are recorded by using a method, the method comprising the steps of:
adding address data to the information data of a specific amount of units so that binary data are formed;
converting the binary data to multi-level data; and
adding other multi-level data for detecting the address data; and thereby the information data are recorded.

10. The information recording medium as claimed in claim 9,
wherein single address data are added to a plurality of the information data of the specific amount of units.

11. The information recording medium as claimed in claim 9,
wherein the count of levels of the other multi-level data for detecting the address data is less than the count of levels of the multi-level data.

12. The information recording medium as claimed in claim 9,
wherein a recording density of the other multi-level data for detecting the address data is lower than a recording density of the multi-level data.
